(19) United States
(12) Patent Application Publication
(10) Pub. No.: US 2011/0069231 A1
(43) Pub. Date: Mar. 24, 2011

(54) IMAGE FORMING APPARATUS AND DISPLAY METHOD OF IMAGE FORMING APPARATUS

(75) Inventor: Michio Yoshitake, Onga-cho (JP)

(73) Assignee: SEIKO EPSON CORPORATION, Shinjuku-ku (JP)

(21) Appl. No.: 12/885,269

(22) Filed: Sep. 17, 2010

(30) Foreign Application Priority Data
Sep. 18, 2009 (JP) 2009-216441

(51) Int. Cl. H04N 7/00

(52) U.S. Cl. 348/552; 348/E07.001

(57) ABSTRACT

Provided is an Image Forming Apparatus Including: an Image Forming Unit Configured to receive print data and to form an image corresponding to the print data on a recorded material; a display unit configured to receive display data and to display a video corresponding to the display data; and a control unit configured to execute an image forming operation for outputting the print data with respect to the image forming unit and a display operation for periodically outputting the display data with respect to the display unit at a predetermined frame rate, wherein the control unit changes the frame rate according to a progress status of the image forming operation.

### BACKGROUND

1. Technical Field

The present invention relates to an image forming apparatus including both an image forming unit for forming an image on a material to be recorded and a display unit for displaying a video, and a display method of the apparatus.

2. Related Art

In an image forming apparatus for forming an image on a material to be recorded such as paper, a display unit for informing a user of information such as an operation method or a progress status of an operation is provided. For example, in an image forming apparatus described in JP-A-2008-186112 (for example, FIGS. 2 and 3), a help menu is displayed on a liquid crystal display mounted in the apparatus so as to enable a user to easily manipulate the apparatus with a small amount of work.

In order to realize such a function, in an image forming apparatus of the related art, a dedicated device such as a controller IC for controlling a liquid crystal display or a memory for storing display data was mounted.

In such a type of apparatus, there is a demand for further miniaturization and lower costs. Therefore, even with respect to the control of a display unit which was performed by the dedicated device of the related art, a System On a Chip (SOC) for controlling the overall apparatus is preferably assembled. In this case, the SOC requires a process of displaying a predetermined video even on the display unit while performing an image forming operation for forming an image on a recorded material. Meanwhile, a video to be displayed becomes complicated with multi-functionalization of the apparatus.

In particular, recently, since enlargement and high quality of a screen of a display unit is in progress, the screen is desired to be used for a so-called slide show display for periodically switching and displaying other uses, for example, images such as photos as well as for a simple manipulation guide. If such a display process is included, it may have influence on the image forming operation. Thus, it is difficult to perform the video display and the image forming operation in parallel on a single SOC.

### SUMMARY

An advantage of some aspects of the invention is that it provides a technique of displaying various videos without having influence on an image forming operation with a small size and low cost in an image forming apparatus including both an image forming apparatus for forming an image on a material to be recorded and a display unit for displaying a video and a display method of the apparatus.

According to an aspect of the invention, there is provided an image forming apparatus including: an image forming unit configured to receive print data and to form an image corresponding to the print data on a recorded material; a display unit configured to receive display data and to display a video corresponding to the display data; and a control unit configured to execute an image forming operation for outputting the print data with respect to the image forming unit and a display operation for periodically outputting the display data with respect to the display unit at a predetermined frame rate, wherein the control unit changes the frame rate according to a progress status of the image forming operation.

In this invention, the frame rate of the display unit is not constant and is changed according to the progress status of the image forming operation. Therefore, it is possible to prevent the display operation from having influence on the image forming operation. For example, if a time in print data processing is necessary during the image forming operation, the frame rate is decreased such that the load applied to the control unit by the display operation is reduced. In contrast, when the image forming operation is not executed, since the control unit spends time on the display operation, advanced video display can be realized. Since the allocation of the video display process and the image forming process is optimized by changing the frame rate, a dedicated device for display may be omitted. Therefore, it is possible to realize miniaturization and low cost of the apparatus while realizing complicated video display.

The control unit may set the frame rate to a first frame rate when the image forming operation is not executed, change the frame rate to a second frame rate slower than the first frame rate when the output of the print data corresponding to an image corresponding to one page to the image forming unit begins, and change the frame rate to the first frame rate when the output of the print data corresponding to the image corresponding to one page ends.

If the image forming operation is not executed, the control unit can spend the processing time on the display operation, and transmit the display data at the first frame rate which is relatively high, such that various advanced videos can be displayed. In contrast, when the image forming operation begins and the output of the print data begins, the frame rate is decreased to the second frame rate, such that it is possible to prevent the display operation from having influence on the image forming operation. When the output of the print data ends, the frame rate is returned to the first frame rate such that various videos can be continuously displayed.

In this case, when a first image forming operation for forming a first image on a first material to be recorded and a second image forming operation for forming a second image on a second material to be recorded are continuously executed, the control unit may output the display data corresponding to a first still image to the display unit at the second frame rate during the execution of the first image forming operation, output the display data corresponding to a second still image to the display unit at the second frame rate during the execution of the second image forming operation, and output the display data corresponding to a switching video for switching the first still image and the second still image at the first frame rate between the first image forming operation and the second image forming operation.

When images are sequentially and continuously formed on a plurality of recorded materials, the print data does not need to be output during the replacement of the recorded material. By executing a process of switching a video to be displayed in this period, it is possible to switch and display a plurality of still images in synchronization with the image formation. At this time, by increasing the frame rate, it is possible to smoothly switch two still images or to perform switching with various visual effects.

In addition, the control unit may divide the print data corresponding to the image corresponding to one page into a plurality of blocks and output each of the blocks to the image forming unit at intervals of a predetermined non-output period, and output the display data corresponding to a switching video for switching two still images during the non-output period so as to display different two still images on the display unit before and after the non-output period, in the image forming operation. By this configuration, it is possible to switch and display a plurality of still images while the image forming unit forms an image corresponding to one page.

In this case, similar to the above, in the non-output period in which the switching video is displayed on the display unit, the frame rate may be changed to the first frame rate. By this configuration, it is possible to smoothly switch two still images or to apply various visual effects.

The control unit may execute a preparation process of the display data corresponding to the switching video in the non-output period different from a period, in which the switching video is displayed on the display unit, of the non-output period.

In addition, the image forming unit may include a transport mechanism configured to pitch feed the material to be recorded in a first direction and a print head configured to supply a coloring agent to the material to be recorded in correspondence with the print data while being scanned and moved in a second direction crossing the first direction, and form an image on the material to be recorded by alternately executing the pitch feeding by the transport mechanism and scanning by the print head, and the control unit may apply the print data to the image forming unit in synchronization with the scanning by the print head and set a period, in which the pitch feeding by the transport mechanism is performed, as the non-output period.

If the image forming unit has the above configuration, the supply of the print data from the control unit to the print head is necessary when the scanning by the print head is executed, but is not necessary when the pitch feeding of the material to be recorded is executed. Accordingly, this period is set as the non-output period such that the display process can be executed while the transporting of the material to be recorded is executed.

According to an aspect of the invention, there is provided a display method of an image forming apparatus including: forming an image on a recorded material; displaying a predetermined video by applying display data to a display unit at a predetermined frame rate while the forming of the image is executed; and changing a frame rate of the display data corresponding to a video displayed on the display unit according to a progress status of the forming of the image. In this invention, similar to the image forming apparatus, it is possible to realize miniaturization and low cost regarding the apparatus while realizing complicated video display without having influence on the forming of the image.

### BRIEF DESCRIPTION OF THE DRAWINGS

The invention will be described with reference to the accompanying drawings, wherein like numbers reference like elements.

FIG. 1 is a perspective view showing an example of a photo printer to which the invention is suitably applicable.

FIG. 2 is a schematic diagram showing the internal configuration of the photo printer.

FIG. 3 is a block diagram showing the electrical configuration of the photo printer of FIG. 1.

FIG. 4 is a block diagram showing the configuration of an LCD controller.

FIG. 5 is a block diagram showing the configuration of a synchronization signal generation unit.

FIG. 6 is a flowchart illustrating a first embodiment of a slide show operation.

FIG. 7 is a flowchart illustrating a switching process of the first embodiment.

FIG. 8 is a flowchart illustrating a frame rate update process.

FIG. 9 is a timing chart showing the slide show operation of the first embodiment.

FIG. 10 is a timing chart showing a slide show operation of a second embodiment.

FIG. 11 is a flowchart illustrating a second embodiment of a slide show operation.

FIG. 12 is a diagram showing a switching process of the second embodiment.

### DESCRIPTION OF EXEMPLARY EMBODIMENTS

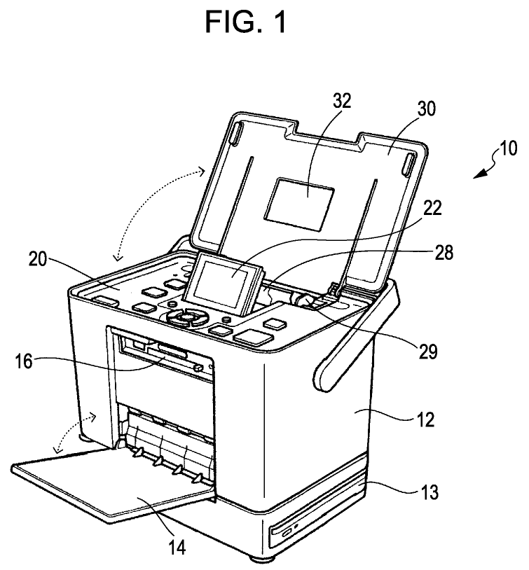

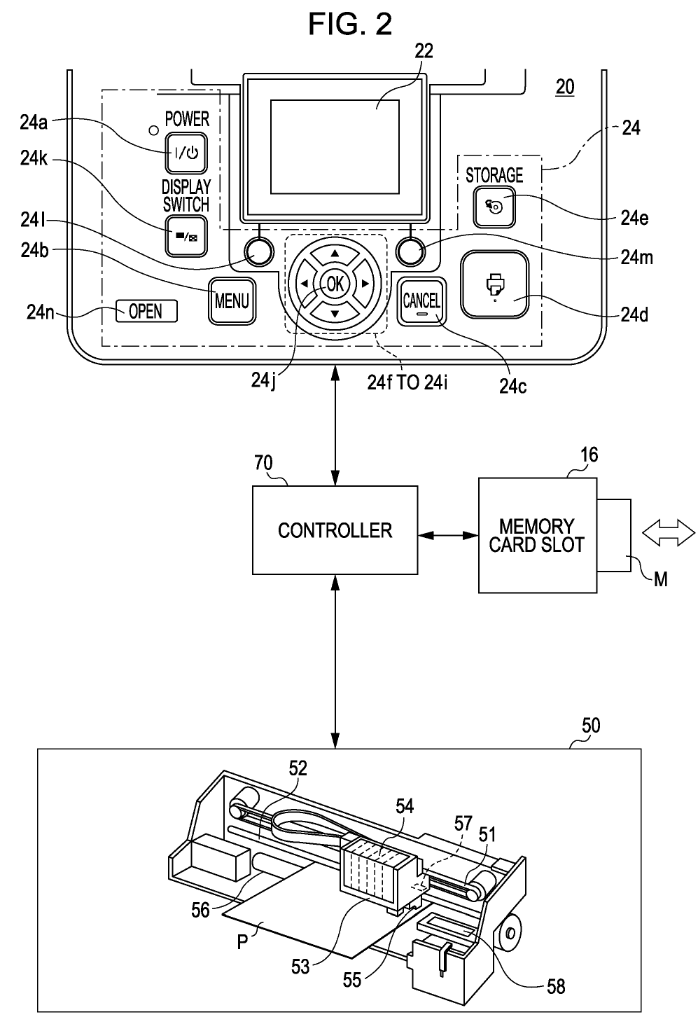

FIG. 1 is a perspective view showing an example of a photo printer to which the invention is suitably applicable. FIG. 2 is a schematic diagram showing the internal configuration of the photo printer. In the photo printer 10, a print mechanism 50 is mounted in a printer main body 12 and executes printing on paper P according to an operation instruction from a controller 70 for controlling the print mechanism 50. Then, the printed paper P is ejected to a front surface of the printer main body 12.

In the front surface of the printer main body 12, a front-surface door 14 is openably mounted. The front-surface door 14 is a lid for opening and closing the front surface of the printer main body 12. In an opened state, the front-surface door functions as an ejection tray for receiving the paper P ejected from the print mechanism 50. In addition, a user can use various memory card slots 16 mounted on the front surface of the printer main body 12. That is, in this state, the user can insert a memory card M in which an image file to be printed is stored into the memory card slot 16. In this embodiment, a disc such as a Compact Disc Recordable (CD-R) or a video Digital Versatile Disc (DVD) may be used as a storage medium, in addition to the memory card. That is, an optical disc drive 13 is mounted in a base portion of the printer main body 12.

A manipulation panel 20 is mounted on the surface of the printer main body 12 and a cover 30 is openably mounted on one side of the inside of the surface of the printer main body 12. This cover 30 is a resin plate with a size capable of covering the surface of the printer main body 12 and externally exposes the surface of the manipulation panel 20 in an opened state. Meanwhile, when the cover 30 is closed, the overall manipulation panel 20 is covered.

In the manipulation panel 20, a display unit 22 composed of, for example, a Liquid Crystal Display (LCD) for displaying characters, figures, or symbols or the like and a button group 24 arranged in vicinity of the display unit 22 are included. The button group 24 includes a power button 24a for turning power on or off, a menu button 24b for calling a main menu screen, a cancel button 24c for canceling manipulation or interrupting printing on the paper P in the middle, a print button 24d for instructing the execution of printing on the paper P, a storage button 24e for storing an edited image or the like in the memory card M inserted into the memory card slot 16, upper, lower, left and right arrow buttons 24f to 24i manipulated when a desired choice is selected from a plurality of choices displayed on the display unit 22 or a cursor is moved, an OK button 24j which is placed on the central portion of the upper, lower, left and right arrow buttons 24f to 24i so as to indicate the decision of the choice selected by the arrow buttons 24f to 24i, a display switch button 24k for switching a screen display on the display unit 22, a left guide selection button 24l for selecting a left guide displayed on the display unit 22, a right guide selection button 24m for selecting a right guide displayed on the display unit 22, and an ejection tray open button 24n for opening the front-surface door 14 functioning as the ejection tray, as shown in FIG. 2.

In order to check the display contents of the display unit 22, a window 32 with the same size as the display unit 22 is mounted in the cover 30. That is, when the cover 30 is closed, the user may check the display contents of the display unit 22 through the window 32. Meanwhile, when the cover 30 is opened, it is possible to adjust the display unit 22 to a desired angle as shown in FIG. 1.

When the cover 30 is opened, the cover 30 is maintained in a state of being obliquely inclined backward with respect to the manipulation panel 20 and can be used as a tray for feeding the paper P to the print mechanism 50. On the inside of the manipulation panel 20, a paper feeding port 28 of the print mechanism 50 is mounted and a pair of paper guides 29 for sliding the paper in a horizontal direction so as to match a guide width to the width of the paper is mounted.

The paper P is transported to the print mechanism 50 through the paper feeding port 28 such that printing is executed. In the print mechanism 50, as shown in FIG. 2, a carriage 53 is driven by a timing belt 51 stretched in a loop shape in a horizontal direction and is reciprocally moved in the horizontal direction along a guide 52. In the carriage 53, a sensor 57 is mounted so as to detect left and right ends or upper and lower ends of the paper P. That is, the sensor 57 detects the left and right end of the paper so as to recognize the width of the paper or detects the back end of the paper during printing so as to recognize the length of the paper, when the carriage 53 is scanned in the horizontal direction with respect to the paper set in the paper feeding port 28 before printing.

In this carriage 53, ink cartridges 54 in which inks of respective colors such as cyan, magenta, yellow and black are individually contained are mounted. Such ink cartridges 54 are connected to print heads 55, respectively. The print heads 55 apply pressure to the inks from the ink cartridges 54 so as to discharge the inks from nozzles (not shown) toward the paper P. In this embodiment, in the print heads 55, a method of applying a voltage to a piezoelectric element so as to modify the piezoelectric element such that the inks are pressurized is employed. However, a method of pressuring the inks by air bubbles generated by applying a voltage to a heating resistive element (for example, a heater or the like) and heating the inks may be employed. The printed paper P is transported to the front-surface door (ejection tray) 14 in the opened state by a transport roller 56. In addition, in order to form an image, a toner or a development agent may be used instead of the inks.

At a position facing the print heads 55 when the carriage 53 shown in FIG. 2 is moved to a cap position of a rightmost side in a movable range, a cap 58 is mounted. The cap 58 is applied over the nozzles of the print heads 55 when a print operation is not performed for a long period of time so as to prevent clogging of the nozzles due to the drying of the inks Even when the apparatus is powered off, the carriage 53 is positioned at the cap position and the nozzles are capped.

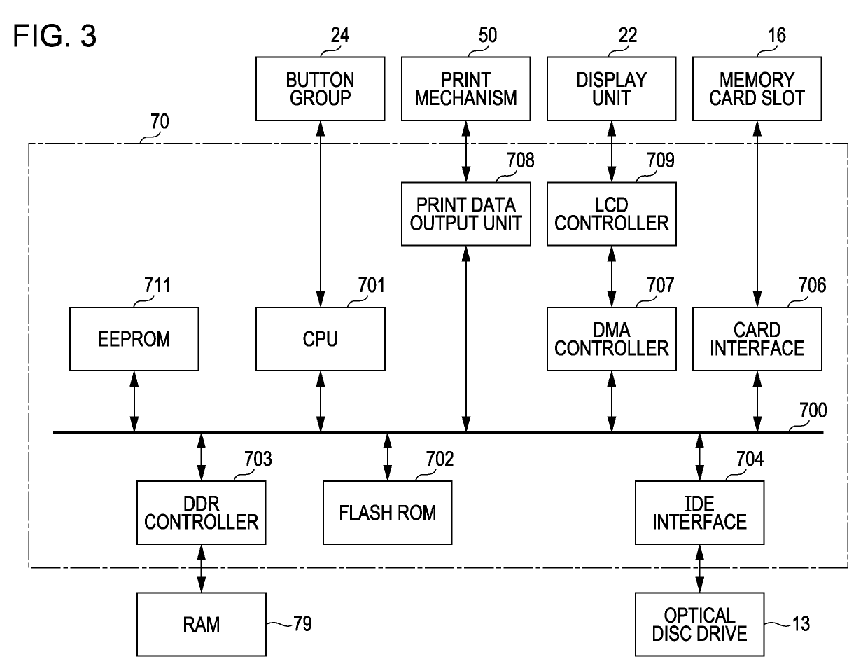

FIG. 3 is a block diagram showing the electrical configuration of the photo printer of FIG. 1. The controller 70 is composed of a System On a Chip (SOC) in which a plurality of functional blocks is integrated on one chip and has a system bus 700 as shown in FIG. 3. This system bus 700 is connected with a CPU 701, a flash ROM 702, a Double Date Rate (DDR) controller 703, an Integrated Drive Electronics (IDE) interface 704, an EEPROM 711, a card interface 706, a Direct Memory Access (DMA) controller 707, a print data output unit 708, an LCD controller 709, and the like.

The CPU 701 performs arithmetic processing for executing operation control of the print mechanism 50. The flash ROM 702 is an electrically repeated rewritable non-volatile memory, which stores a program (firmware) necessary for the control of the CPU 701 or a variety of data, tables or the like necessary for the control thereof. The EEPROM 711 is also an electrically repeated rewritable memory, which stores data to be stored even when the power source of the apparatus is turned off.

The DDR controller 703 is externally attached to the controller 70 so as to access a DDR type high-speed RAM 79 for temporarily storing data necessary for the operation of the CPU 701 or data processing. The card interface 706 performs communication with the memory card slot 16 and reads image data of an external storage medium such as the memory card M inserted into the memory card slot 16. The card interface 706 writes image data in the memory card M in order to store an edited image or the like. The IDE interface 704 transmits or receives data to or from the optical disc driver 13.

The CPU 701 performs necessary image processing with respect to image data received from the external storage medium such as the memory card M read by the card interface 706, generates print data corresponding to the image to be printed by the print mechanism 50, and transmits the print data to the print data output unit 708. For example, synthesis image data obtained by synthesizing the image data read from the memory card M and the image frame data read from the flash ROM 702 is prepared and output to the print data output unit 708. The print data output unit 708 generates a print control signal based on the image data prepared by the CPU 701 and outputs the print control signal to the print mechanism 50. The print mechanism 50 executes a print operation based on the print control signal and forms an image corresponding to an image file on paper.

The CPU 701 performs polling to check whether or not each of the manipulation buttons configuring the button group 24 is pressed by the user in a predetermined period, for example, at an interval of 200 msec, and executes a reception process corresponding to the manipulated button when it is detected how many buttons are manipulated by the user. For example, if the power button 24a is pressed by the user in a state in which the power source of the apparatus is turned on, the supply of power to the respective units of the apparatus is stopped. In addition, for example, when the print button 24d is pressed, image data is applied to the print data output unit 708 so as to prepare the print control signal and the print mechanism 50 performs a print operation.

In addition, the CPU 701 performs a process (hereinafter, referred to as a “display process”) of preparing display data corresponding to a video to be displayed on the display unit 22. The video to be displayed on the display unit 22 includes a preview image corresponding to the image formed by the print mechanism 50, a still image and animation video for informing the user of a manipulation method or a progress status of the process, a demonstration moving image, and the like. The contents of the video other than the preview image are determined in advance and video data corresponding to such a video is stored in the flash ROM 702.

In the flash ROM 702, information indicating whether the video is any one of the still image, the animation and the moving image or information about an optimal frame rate for displaying the video is stored together with the video data. The still image described herein is a video, the display contents of which are not changed for a predetermined period of time if the manipulation of the user or the progress status of the process is not changed. The animation video is a video with simple motion, in which the video is partially blinked or a specific character is moved on the screen. The moving image is a video with smooth motion in the overall screen.

The CPU 701 reads data from the flash ROM 702 and stores the display data processed by, for example, synthesis with the preview image as necessary in the RAM 79. The display data prepared on the RAM 79 is periodically sent to the LCD controller 709 through the DMA controller 707, and the LCD controller 709 generates a video signal based on the received display data and outputs the video signal to the display unit 22. Therefore, the image corresponding to the display data is displayed on the display unit 22.

In addition, this photo printer 10 has a so-called slide show function for reading the images stored in the storage medium such as the memory card M and sequentially displaying the images on the display unit 22. That is, this photo printer 10 can execute an operation (slide show operation) for reading and displaying an image stored in the storage medium such as the memory card M inserted into the memory card slot 16 or an optical disc inserted into the optical disc drive 13 on the display unit 22 for a predetermined period of time and then switching and displaying another image read from the storage medium. This slide show operation can be executed when the print mechanism 50 performs the print operation as well as when the print mechanism 50 does not perform the print operation. The slide show operation will be described later.

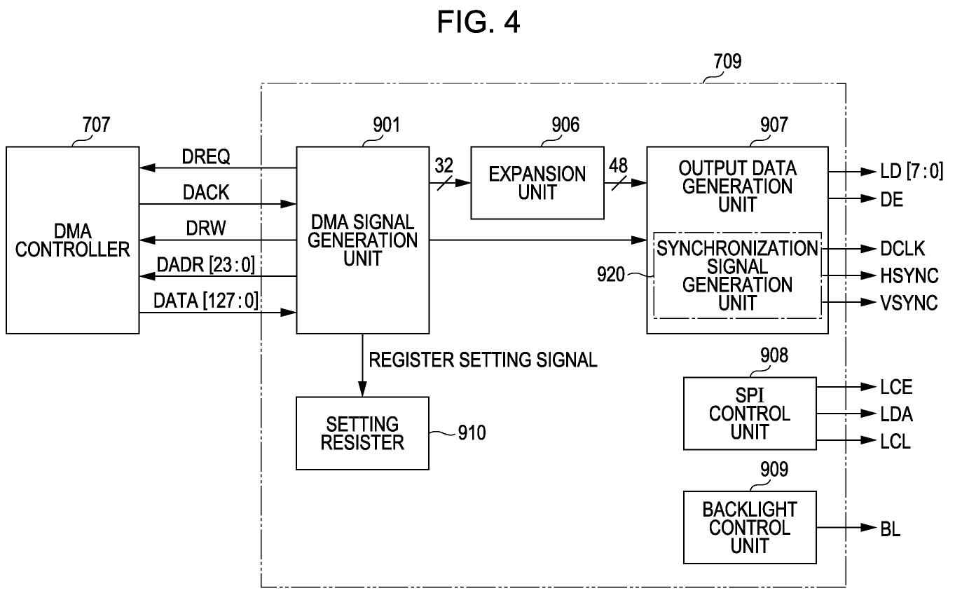

FIG. 4 is a block diagram showing the configuration of an LCD controller. The LCD controller 709 includes a DMA signal generation unit 901, an expansion unit 906, an output data generation unit 907, an SPI control unit 908, a backlight control unit 909, a setting register 910, and the like.

The DMA signal generation unit 901 functions as an interface for exchanging data with the DMA controller 707. In detail, when data is not present in an internal data buffer, a data request signal DREQ is output to the DMA controller 707. In addition, the DMA signal generation unit 901 outputs a direction of requested access to the RAM 79, that is, a direction signal DRW defining whether the access is data writing or reading, and an address signal DADR indicating the address of the RAM 79 to be accessed to the DMA controller 707. Accordingly, the DMA controller 707 accesses the specified address of the RAM 79.

The access to the RAM 79 which is requested to the DMA controller 707 by the LCD controller 709 is the reading of the data stored in the RAM 79 as the display data displayed on the display unit 22. Accordingly, the DMA signal generation unit 901 periodically requests the reading of the data from the RAM 79 to the DMA controller 707 at predetermined timing. The DMA controller 707 which receives the request reads the data from the RAM 79, sends an acknowledgement signal DACK to the DMA signal generation unit 901 as a response when the reading is finished, and transmits the read data to the DMA signal generation unit 901.

The data read from the RAM 79 based on the request of the DMA signal generation unit 901 is input to the expansion unit 906. Since 32-bit data obtained by compressing display data is stored in the RAM 79, the expansion unit 906 expands the compressed display data and outputs the data to the output data generation unit 907 as display data (48 bits) corresponding to two screens.

The output data generation unit 907 performs signal processing such as stripe delta conversion, gamma correction or the like with respect to the applied 48-bit data and transmits the data to the display unit 22 in a predetermined data transmission order. In addition, the output data generation unit 907 includes a synchronization signal generation unit 920 for generating various synchronization signals for operating the display unit 22. The configuration of the synchronization signal generation unit 920 will be described later.

The SPI control unit 908 transmits a control command to the display unit 22 using a Serial Peripheral Interface (SPI) method. The backlight control unit 909 controls the brightness of the screen by applying a control signal BL indicating a light-on duty of a backlight (not shown) mounted in the display unit 22 to the display unit 22. The configuration or the function of each of the functional blocks is known and thus description thereof will be omitted herein.

The setting register 910 holds a value of an internal register for deciding an operation mode of the LCD controller 709. A register setting signal from the DMA signal generation unit 901 is input to the setting register 910. As described below, a portion of the set values of the setting register 910 is set based on a register setting signal received from the DMA signal generation unit 901.

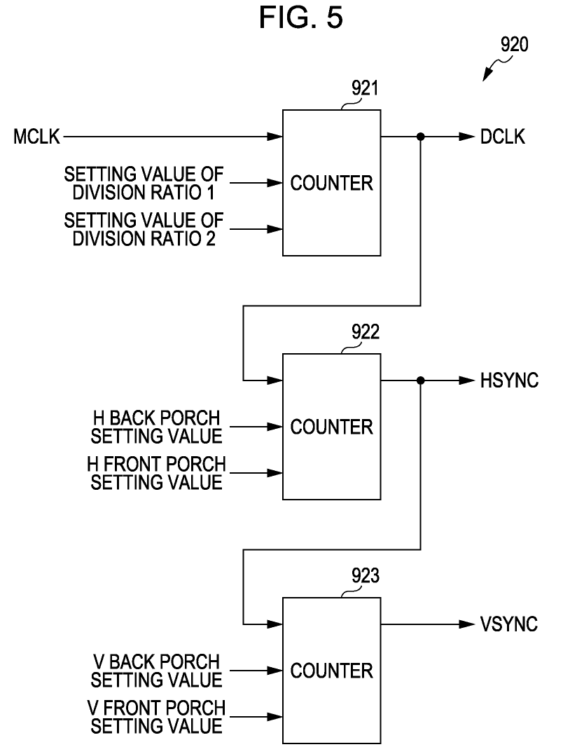

FIG. 5 is a block diagram showing the configuration of the synchronization signal generation unit. The synchronization signal generation unit 920 includes three counters 921, 922 and 923 which are respectively programmable counters. An original clock signal MCLK generated by an original clock generator (not shown) is input to the first counter 921. The first counter 921 outputs a clock signal obtained by dividing the original clock signal by an adequate division ratio as a pixel clock signal DCLK for deciding a transmission period of display data transmitted to the display unit 22. The division ratio is decided by two setting values stored in the setting register 910, that is, the setting values of a division ratio 1 and a division ratio 2.

The pixel clock signal DCLK is also input to the second counter 922. The second counter 922 further divides the pixel signal clock DCLK and generates and outputs horizontal synchronization signal HSYNC. In detail, a signal obtained by applying predetermined back porch and front porch determined by a H back porch setting value and a H front porch setting value set in the setting register 910 to the signal obtained by dividing the pixel clock signal DCLK by a predetermined division ratio is output as the horizontal synchronization signal HSYNC.

Similarly, the third counter 923 divides the horizontal synchronization signal HSYNC output from the second counter 922 and outputs a signal obtained by applying predetermined back porch and front porch based on a V back porch setting value and a V front porch setting value set in the setting register 910 as a vertical synchronization signal VSYNC. Such a signal is transmitted to the display unit 22 which is an LCD display so as to be used for display timing control of the display unit 22.

Among the setting values stored in the setting register 910, the division 1 and the division 2 are set by a register setting signal. The DMA signal generation unit 901 applies data for setting the division 1 and the division 2 to the setting register 910 as the register setting signal, based on the command received from the CPU 701. Thus, the division 1 and the division 2 in the setting register 910 are set.

Accordingly, in this embodiment, the division ratio when the pixel clock signal DCLK is generated from the original clock signal MCLK is decided according to an instruction from the CPU 701. In addition, since the pixel clock signal DCLK is the original clock signal of the horizontal synchronization signal HSYNC and the vertical synchronization signal VSYNC, the period of the timing signal sent to the display unit 22 may be changed by the setting values of the division ratio 1 and the division ratio 2. That is, it is possible to change and set the frame rate of the display unit 22.

Next, two embodiments for realizing the slide show function will be described. Here, the slide show function is known because equipment for software for realizing this function is commercially available. When the print mechanism 50 does not perform a print operation, the slide show operation can be performed by a known technique. Hereinafter, a process when the CPU 701 executes a slide show operation in parallel with a print operation of the print mechanism 50 will be the focus of the description.

The biggest problem in the case where the print operation and the slide show operation are performed in parallel is how the processing capability of the controller 70 is distributed to the two operations. Since the access to the RAM 79 needs to be frequently executed in both such processes, in particular, the two processes compete for the access to the RAM 79 and thus inconvenience such as the delay of the respective processes may be caused. The following operation solves this problem.

### First Embodiment

First, a first embodiment of the slide show operation executed by the photo printer 10 will be described. The slide show operation of this embodiment is an operation for sequentially displaying a plurality of still images on the display unit 22 while switching in the case where the print mechanism 50 sequentially forms images on a plurality of sheets of paper P. In detail, the image read from the memory card M or the like is displayed on the display unit 22 as a still image while the print mechanism 50 forms the image on one sheet of paper P, the display image is switched when the formation of the image on the paper is finished and next paper is fed, and a new image read from the memory card M or the like is displayed on the display unit 22 as a still image.

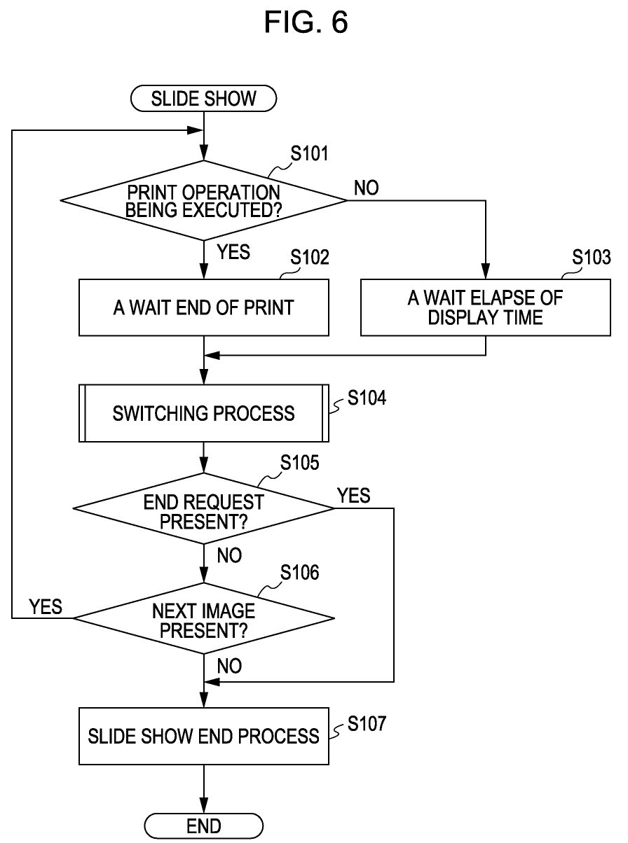

FIG. 6 is a flowchart illustrating a first embodiment of a slide show operation. If the print mechanism 50 is executing the print operation with respect to the paper P when a slide show begins (step S101), the end of the print operation with respect to the paper is awaited (step S102). In contrast, if the print operation is not being executed, the elapse of a predetermined display time corresponding to a time for continuously displaying one still image is awaited (step S103). By defining slide show start timing, the slide show can begin in synchronization with the print operation of the print mechanism 50. In addition, before the slide show begins, an initial image prepared in advance and stored in the RAM 79 is displayed on the display unit 22 at a frame rate of 60 Hz. Subsequently, a predetermined switching process (step S104) is executed.

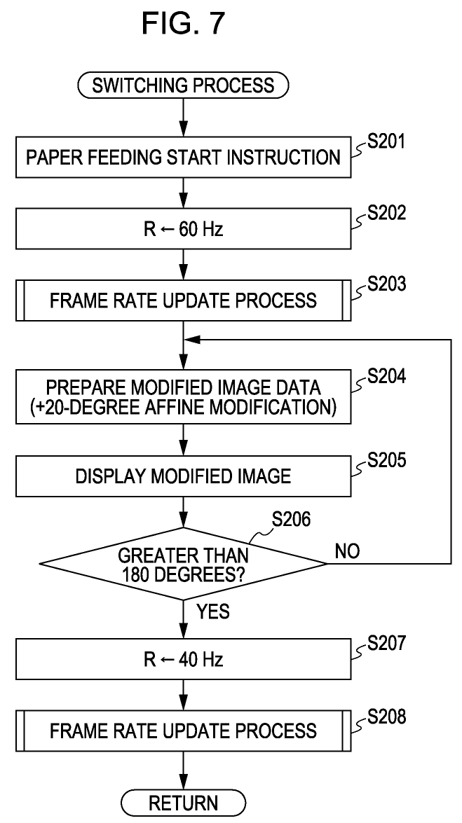

FIG. 7 is a flowchart illustrating the switching process of the first embodiment. In the switching process, first, a paper feeding start instruction is output to the print mechanism 50 (step S201). Accordingly, the print mechanism 50 starts the print operation with respect to new paper P. Next, a request value R of the frame rate of the display data output to the display unit 22 is set to 60 Hz and a frame rate update process (step S203) is executed.

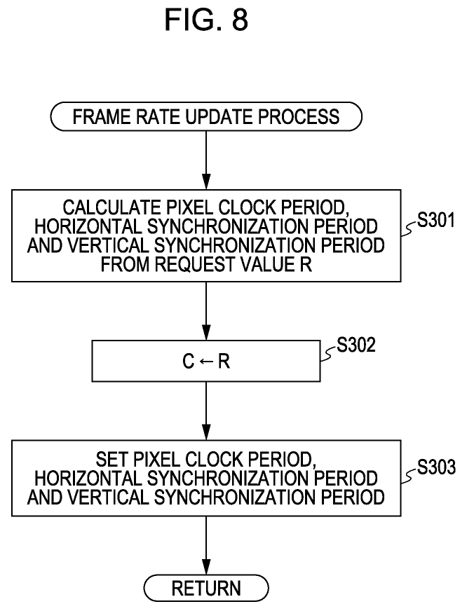

FIG. 8 is a flowchart illustrating the frame rate update process. In this process, the pixel clock period, the horizontal synchronization period, the vertical synchronization period and the like corresponding to the rate are calculated from the set frame rate request value R (step S301). A current frame rate setting value C is updated to the request value R (step S302). In detail, the parameter division 1 and division 2 corresponding to the new frame rate setting value is written in the RAM 79. Such parameters are applied to the LCD controller 709 through the DMA controller 707 and are written from the DMA signal generation unit 901 to the setting register 910 such that the calculated pixel clock period, the horizontal synchronization period and the vertical synchronization period and the like become new setting values (step S303). Thus, the frame rate is changed.

Returning to FIG. 7, the switching process will continue to be described. By setting the frame rate request value R to 60 Hz and executing the frame rate process (steps S202 to S203, the frame rate is set to 60 Hz. The frame rate of 60 Hz is a rate equal to that of television broadcast and can smoothly display a moving image.

Subsequently, image data corresponding to the image (first still image) which is currently displayed on the display unit 22 is processed so as to prepare modified image data corresponding to one screen (step S204). Here, although (+20)-degree affine transformation is executed herein, the processing is not limited thereto and is arbitrary. For example, a wipe process, a fade process, an overlay process, a slide process or the like, which are widely used in this type of image processing, may be performed.

In addition, the affine-transformed image is superposed on an image (second still image) to be displayed next, for example, an image corresponding to a photo image read from the memory card M so as to obtain modified image data. In the case where the image stored in the memory card M is displayed on the display unit 22, it is preferable that the image data to be displayed is read from the memory card M in advance and is stored in the RAM 79.

The creation of the modified image data causes a visual effect in which the video is not instantly switched but is gradually changed when the video to be displayed on the display unit 22 is switched from the first still image to the second still image. The modified image data is written in the RAM 79 and is periodically transmitted from the RAM 79 to the LCD controller 709 through the DMA controller 707 at a previously set frame rate. Then, the modified image obtained by modifying the previous image is displayed on the display unit 22 (step S205).

By repeating steps S204 and S205 until a rotation angle exceeds 180 degrees (step S206), a video continuously switched from the first still image to the second still image can be displayed on the display unit 22 with performance by 3D (three-dimensional) visual effect of turning pages of an album. Hereinafter, an arithmetic process of causing such a visual effect is called “3D arithmetic”.

If the display image is switched, the frame rate request value R is decreased to 40 Hz (step S207) and then the frame rate update process is executed again (step S208). Thus, the display frame rate of the display unit 22 is changed from 60 Hz to 40 Hz.

Returning to FIG. 6, the slide show operation will continue to be described. By executing the switching process in step S104, the second still image is displayed on the display unit 22 and the frame rate thereof is set to 40 Hz. In addition, the processes of steps S101 to S104 are repeatedly executed until an end request due to the manipulation input of the user or the request for the operation of the apparatus is applied (step S105) or a new image to be displayed by the slide show disappears (step S106). The slide show operation is summarized as follows.

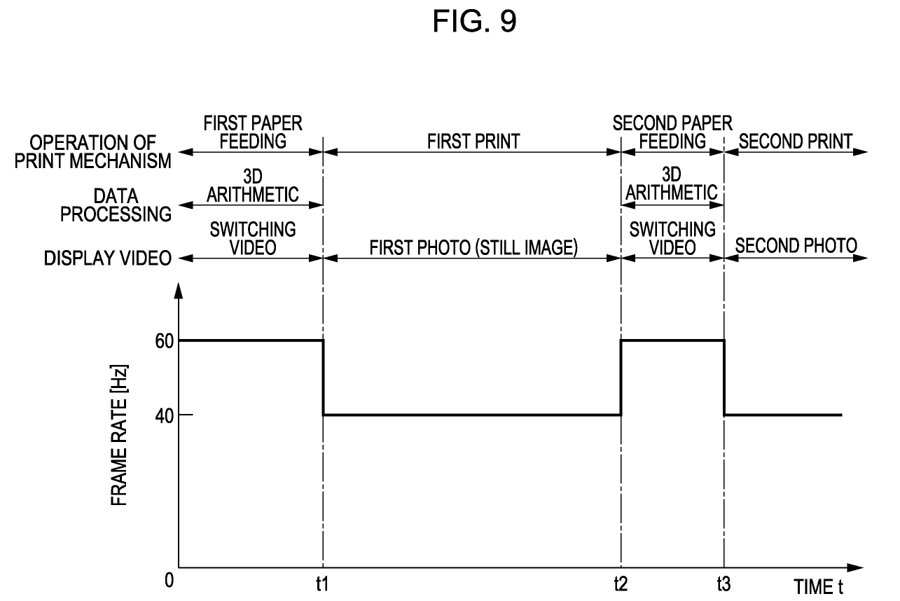

FIG. 9 is a timing chart showing the slide show operation of the first embodiment. First, the operation of the print mechanism 50 will be focused. When the print operation begins at a time t=0, the feeding of the paper P from the paper feeding port 28 to the print mechanism 50 begins. When first paper is set at a predetermined print start position (time t1), the print operation on the paper begins. When print ends at a time t2 and the first paper is ejected, second paper is continuously fed. When the feeding of the second paper ends (time t3), the print operation on the second paper is executed.

Next, the slide show operation will be focused. In the above process, the switching process is executed only when the print mechanism 50 does not execute the print operation, and the switching process is not executed until the print operation ends, if the print operation is being executed. In a period from the time 0 to t1 in which the print operation does not begin with respect to the first paper during an idle period, the switching process is executed and 3D arithmetic is performed, such that the video displayed on the display unit 22 becomes a switching video with motion, which is prepared by the 3D arithmetic process. At this time, the frame rate is 60 Hz.

When the switching process ends, the frame rate of the display unit 22 is changed from 60 Hz to 40 Hz. At this time, the video displayed on the display unit 22 is a still image corresponding to a first photo image read from the memory card M. If a time t2 is reached when the print operation on the first paper ends, the switching process is executed, the frame rate is changed to 60 Hz again, and 3D arithmetic for switching the displayed image from the first photo image to a second photo image is performed, such that the displayed video is switched to a still image corresponding to the second photo image. Furthermore, the frame rate is decreased to 40 Hz. Hereinafter, the same operation is repeated.

As described above, in this embodiment, in the case where the print mechanism 50 executes the print operation, the frame rate of the display unit 22 is set to be less than that in the case where the print operation is not executed. During the execution of the print operation, the access to the RAM 79 is frequently performed in order to prepare print data. Since the display data displayed on the display unit 22 is also stored in the same RAM 79, competition for access is caused and thus the progress of the print operation may be disturbed. In order to solve this problem, in this embodiment, the frequency of data transmission from the RAM 79 to the LCD controller 709 is decreased by decreasing the frame rate of the display unit 22 when is executing the print operation, such that competition for access to the RAM 79 is not caused.

Meanwhile, a video with motion cannot be displayed if a low frame rate is maintained. Accordingly, the frame rate is set to be high (60 Hz) during the transport of the paper before and after the print operation and a 3D arithmetic process of increasing the visual effect is performed with respect to the displayed image such that the image is displayed on the display unit 22. Therefore, as the printing on a plurality of sheets of paper is progressed, the videos displayed on the display unit 22 are also sequentially switched so as to realize the so-called slide show. Since the output of the print data is not necessary during the transport of the paper, there is a margin in the processing capability of the CPU 701 and the frequency of the access to the RAM 79 is also decreased. Therefore, it is possible to allocate the processing capability of the CPU 701 and the access period to the RAM 79 to the process of the display data for display and to transmit the display data at a high frame rate. Accordingly, it is possible to display a video with smooth motion and high visual effect.

With respect to the access to the RAM 79 for which the print operation and the slide show operation may compete, since the allocation to the respective operations can be optimized according to the progress status of the print operation, a process can be performed using a common storage device between the print operation and the slide show operation and thus a dedicated device for display does not need to be used. This is a large advantage regarding miniaturization of the apparatus and reducing cost.

### Second Embodiment

Next, a second embodiment of the slide show operation will be described. In the slide show operation of the first embodiment, the display unit 22 is configured to display one still image whenever the print mechanism 50 forms an image corresponding to one page. In contrast, in the slide show operation of the following second embodiment, the display unit is configured to switch and display a plurality of still images while an image corresponding to one page is formed.

In this photo printer 10, the print operation is progressed by alternately executing scanning movement of the carriage 53 in the horizontal direction and one pitch feeding of the paper P in a direction perpendicular to the scanning movement. That is, by scanning and moving the carriage 53 while discharging the inks from the print heads 55 in correspondence with print data, a band-shaped image corresponding to a portion of an image corresponding to one page is formed on the paper P. Here, the scanning direction of the carriage 53 is referred to as a “main scanning direction”. Subsequently, the transport roller 56 is operated such that the paper P is pitch-fed only by a predetermined pitch in a direction (referred to as a “sub scanning direction”) perpendicular to the main scanning direction, and the carriage 53 is scanned again so as to form a next band-shaped image. By repeating this operation, the band-shaped images are aligned on the paper P so as to form the image corresponding to one page, and the paper P is ejected to the ejection tray 14.

Accordingly, even with respect to a process of forming an image corresponding to one page, the transmission of the print data from the controller 70 is not performed while the paper P is pitch-fed. Using this period, a process of displaying a switching video or 3D arithmetic described in the first embodiment is performed such that the video switching is performed without having influence on the print operation even during the print operation for forming the image corresponding to one page. First, the operation of the apparatus necessary for realizing such a function will be described.

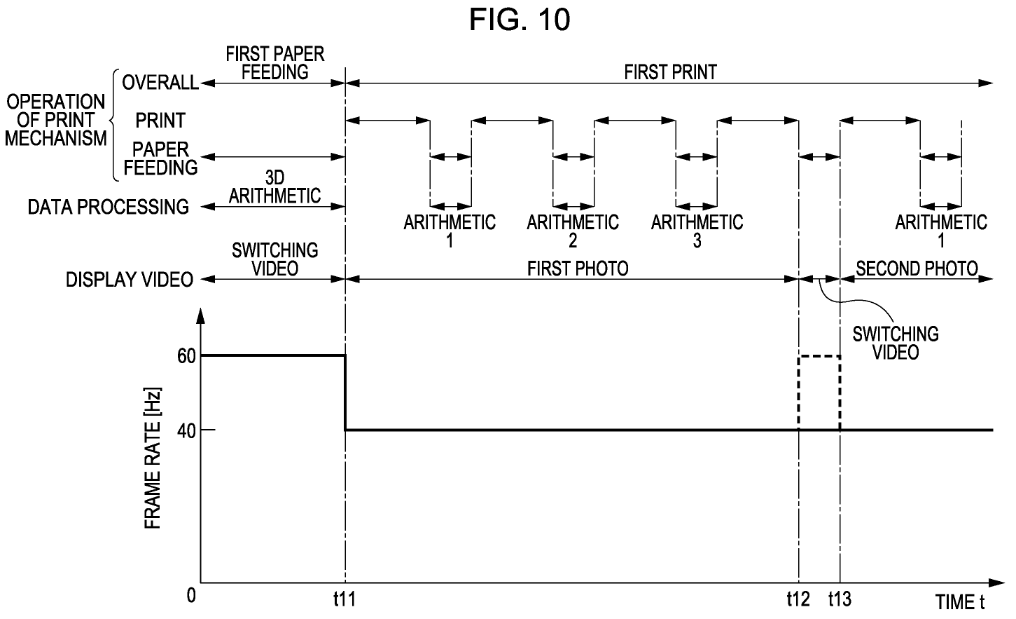

FIG. 10 is a timing chart showing the slide show operation of the second embodiment. In FIG. 10, the operation for forming an image on first paper is partially shown. That is, in the timing charge of FIG. 10, a time axis (horizontal axis) is extended more than that of FIG. 9.

When focusing on the operation of the print mechanism 50, the operation from a time when the operation begins to a time t11 when the first paper reaches the print start position is basically equal to that of the first embodiment. When the print operation begins at the time t11, the carriage 53 is scanned and moved (or reciprocally moved) from one end to the other end of the paper so as to print a band-shaped image, and, when this operation ends, the transport roller 56 feeds the paper by a predetermined pitch. This operation is alternately performed such that the image is formed on the paper.

As an example, it is assumed that the image corresponding to one page is formed by scanning and moving the carriage 53 twelve times. In addition, if paper with a general L-plate size is used as a photo size, the time consumed for scanning and moving the carriage 53 once is about 1 to 2 seconds and the time consumed for paper feeding is about 0.5 seconds.

Next, the slide show operation will be considered. Since the transmission of the print data to the print heads 55 is not performed while the paper is fed by the transport roller 56, there is a margin in the processing capability of the CPU 701 and the RAM 79. Therefore, using this period, the 3D arithmetic to prepare modified image data can be partially executed. “Arithmetic 1”, “arithmetic 2” and “arithmetic 3” shown in FIG. 10 indicate that 3D arithmetic is divided into three times and is executed during a paper transport period.

If the modified image data necessary for image switching is prepared by three-time arithmetic, in the next paper transport period (from a time t12 to a time t13), the display of the switching video using such data is performed such that the display image can be switched from a first photo to a second photo. That is, in this example, the preparation of the modified image data and the switching of the display image can be performed while paper feeding is performed four times. Therefore, if twelve-time scanning movement and paper feeding are executed in order to form the image corresponding to one page, three images can be switched and displayed while the image corresponding to one page is formed.

Similar to the first embodiment, although the display frame rate is 40 Hz during the execution of the print operation, the frame rate may be high (60 Hz) in the period (from the time t12 to the time t13) for switching the display image. Thus, it is possible to display more smooth motion. Since the transmission of the print data and the preparation of the modified image data are not necessary in this period, competition for the access to the RAM 79 is not caused even when the frame rate is increased. Hereinafter, the detailed operation for realizing such a function will be described.

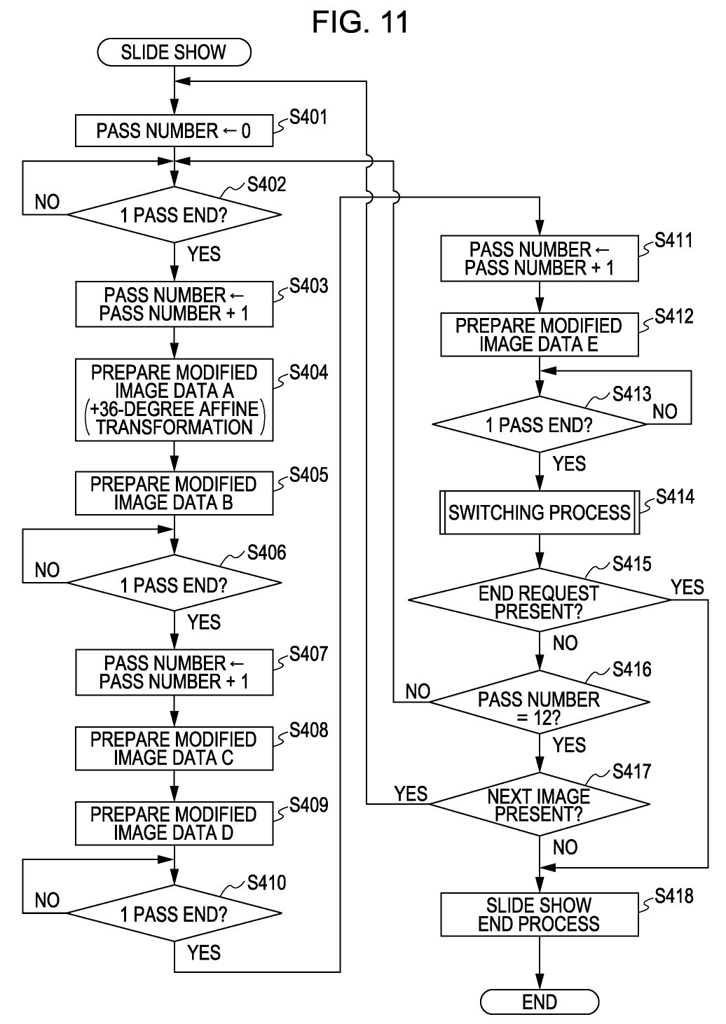

FIG. 11 is a flowchart illustrating the second embodiment of the slide show operation. Here, scanning movement of one time of the carriage 53 is expressed by “pass” and the number of times of executed scanning movement is denoted by “pass number”. First, the pass number is reset to 0 (step S401), and the end of the first scanning movement of the carriage 53, that is, a first pass, is awaited (step S402). 1 is added to the pass number (step S403) whenever one pass ends, and image data corresponding to an image which is being displayed and image data corresponding to an image which will be next displayed are processed so as to prepare modified image data A corresponding to one screen (step S404). Here, as an example, (+36-degree) affine transformation is performed. The prepared modified image data A is not transmitted to the LCD controller 709 and is stored in the RAM 79 at this time point.

Subsequently, similarly, modified image data B is prepared (step S405) and is stored in the RAM 79. Although the modified image data corresponding to 2 screens can be prepared during a single instance of paper feeding, the invention is not limited thereto. According to the paper feeding period and the time consumed for data processing, modified image data corresponding to screens which can be prepared in the period may be prepared.

Subsequently, the next pass, which is a single pass, is executed. Since the processing of the display data for display is stopped in this period, the print operation is not influenced. When one pass ends (steps S406 and S407), similar to the above, modified image data C and modified image data D are sequentially prepared during the paper feed period and are stored in the RAM 79. In addition, when one pass ends (steps S410 and S411), modified image data E corresponding to a fifth screen is prepared (step S412). At a point of time when the next pass ends (step S413), the following switching process is executed (step S414).

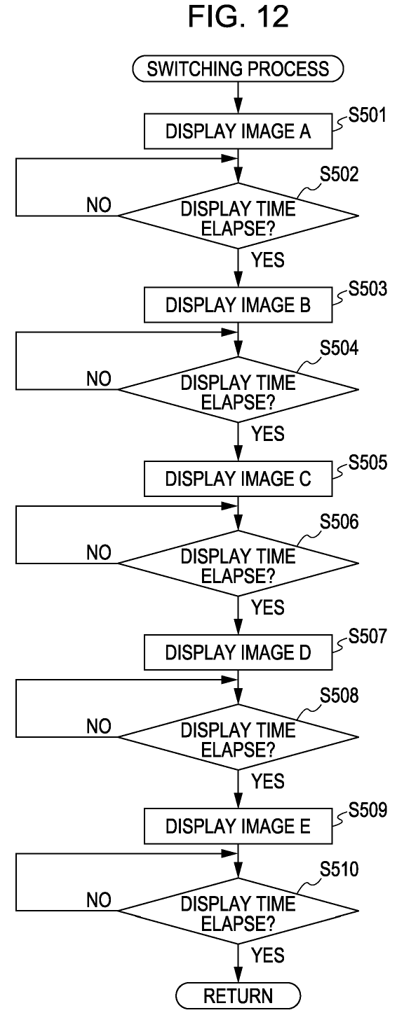

FIG. 12 is a diagram showing the switching process of the second embodiment. This switching process smoothly changes two still images. Here, since the modified image data corresponding to 5 screens configuring the switching video is prepared in advance, this process only sequentially displays the data. That is, the modified image data A is transmitted from the RAM 79 to the LCD controller 709 and a modified image A corresponding to the modified image data A is displayed on the display unit 22 (step S501). After 0.1 seconds elapse (step S502), the displayed image is switched to an image B corresponding to the modified image data B (step S503). Similarly, the image B, the image C and the image D respectively corresponding to the modified image data B, C and D are sequentially displayed on the display unit 22 such that the display image is switched with a performance having a high visual effect as in the first embodiment (steps S504 to S510).

Although the images corresponding to 5 screens are sequentially switched at an interval of 0.1 seconds as the switching video in correspondence with the paper feed time of about 0.5 seconds, the number of prepared screens or a switching period, applied visual effect or the like may be adequately set. In addition, if the frame rate is increased at the time of the switching process, a process of increasing the frame rate from 40 Hz to 60 Hz may be added before step S501 or a process of returning the frame rate to 40 Hz may be added after step S510.

As described above, in this embodiment, the display data processing or the switching process of the display image is executed while the print mechanism 50 forms an image corresponding to one page using the margin in the access to the RAM 79 and the CPU 701 during paper feeding of the print operation. Accordingly, in this embodiment, even while the image corresponding to one page is formed, a plurality of images is switched to be displayed on the display unit 22.

Even in this embodiment, since the display with high visual effect can be executed without having influence on the print operation of the print mechanism 50, this embodiment is equal to the first embodiment in that a special device is not necessary.

In this embodiment, the display image may be switched in a period from a time when the printing on the first paper ends to a time when the second paper is fed. The process of the above first embodiment is applicable to this process.

As described above, in the above embodiments, the print mechanism 50 and the display unit 22 function as an “image forming unit” and a “display unit” of the invention. In addition, the controller 70 functions as a “control unit” of the invention and the print operation of the above embodiments corresponds to an “image forming operation” and an “image forming process” of the invention. In addition, the slide show operation of the above embodiments corresponds to a “display operation” and a “display process” of the invention. In the above embodiments, the transport roller 56 functions as a “transport mechanism” of the invention and the print head 55 functions as a “print head” of the invention. In the above embodiments, the paper P corresponds to a “recorded material” of the invention.

In each embodiment, a “first frame rate” of the invention corresponds to 60 Hz and a “second frame rate” corresponds to 40 Hz. In addition, in the first embodiment, the print operation on the first paper corresponds to a “first image forming operation” of the invention and the print operation on the second paper corresponds to a “second image forming operation” of the invention. In addition, the paper feeding period (for example, from the time t12 to the time t13) of the second embodiment corresponds to a “non-output period” of the invention. The paper feeding direction and the carriage scanning direction of the above embodiments correspond to a “first direction” and a “second direction” of the invention, respectively.

The invention is not limited to the above embodiments and various modifications may be made without departing from the scope of the invention. For example, although the display frame rate of the display unit 22 is switched in two steps of 60 Hz and 40 Hz in the above embodiments, the value of the frame rate is not limited to these values. If human visual characteristics are considered, a frame rate greater than 60 Hz is unnecessary. In contrast, if the frame rate is less than 10 Hz, flicker is conspicuous. Thus, the frame rate is preferably set between 60 Hz and 10 Hz. The frame rate may be changed in three steps or more.

Although the image file stored in the memory card M is read so as to perform the print operation in the above embodiments, the data format of the image file or the storage medium thereof are not limited thereto and various known data formats or storage mediums may be used. For example, a storage medium having a magnetic disc or a stick storage medium may be used. The invention is applicable to equipment having a function for storing a picked-up image file, such as a digital camera or a mobile telephone, in which the image file can be read by, for example, a communication unit performing cable or wireless/infrared communication or the like.

In addition, although the print mechanism 50 of the above embodiments is an ink jet printer, for example, an electrophotographic printer may be used. Although the display unit 22 of the above embodiments displays the image by the LCD display, the image may be displayed by other display systems such as an electroluminescence element (EL) display.

Although the invention is applied to the photo printer having the display function for displaying the image corresponding to the image file and the print function for printing the image in the above embodiment, the application of the invention is not limited to the photo printer and the invention is applicable to all equipment having a display function and a print function. In particular, the invention is particularly efficient in equipment with a small size and low cost.

What is claimed is:

1. An image forming apparatus comprising:
an image forming unit configured to receive print data and to form an image corresponding to the print data on a recorded material;
a display unit configured to receive display data and to display a video corresponding to the display data; and
a control unit configured to execute an image forming operation for outputting the print data with respect to the image forming unit and a display operation for periodically outputting the display data with respect to the display unit at a predetermined frame rate,
wherein the control unit changes the frame rate according to a progress status of the image forming operation.

2. The image forming apparatus according to claim 1, wherein the control unit sets the frame rate to a first frame rate when the image forming operation is not executed, changes the frame rate to a second frame rate slower than the first frame rate when the output of the print data corresponding to an image corresponding to one page to the image forming unit begins, and changes the frame rate to the first frame rate when the output of the print data corresponding to the image corresponding to one page ends.

3. The image forming apparatus according to claim 2, wherein, when a first image forming operation for forming a first image on a first material to be recorded and a second image forming operation for forming a second image on a second material to be recorded are continuously executed, the control unit outputs the display data corresponding to a first still image to the display unit at the second frame rate during the execution of the first image forming operation, outputs the display data corresponding to a second still image to the display unit at the second frame rate during the execution of the second image forming operation, and outputs the display image corresponding to a switching video for switching the first still image and the second still image to the display unit at the first frame rate between the first image forming operation and the second image forming operation.

4. The image forming apparatus according to claim 2, wherein the control unit divides the print data corresponding to the image corresponding to one page into a plurality of blocks and outputs each of the blocks to the image forming unit at intervals of a predetermined non-output period, and outputs the display data corresponding to a switching video for switching two still images during the non-output period so as to display different two still images on the display unit before and after the non-output period, in the image forming operation.

5. The image forming apparatus according to claim 4, wherein the control unit changes the frame rate to the first frame rate in the non-output period in which the switching video is displayed on the display unit.

6. The image forming apparatus according to claim 4, wherein the control unit executes a preparation process of the display data corresponding to the switching video in the non-output period different from the non-output period in which the switching video is not displayed on the display unit.

7. The image forming apparatus according to claim 4, wherein:
the image forming unit includes a transport mechanism configured to pitch feed the material to be recorded in a first direction and a print head configured to supply a coloring agent to the material to be recorded in correspondence with the print data while being scanned and moved in a second direction crossing the first direction, and forms an image on the material to be recorded by alternately executing the pitch feeding by the transport mechanism and scanning by the print head, and
the control unit applies the print data to the image forming unit in synchronization with the scanning by the print head and sets a period, in which the pitch feeding by the transport mechanism is performed, as the non-output period.

8. A display method of an image forming apparatus, the display method comprising:
forming an image on a recorded material;
displaying a predetermined video by applying display data to a display unit at a predetermined frame rate while the forming of the image is executed; and
changing a frame rate of the display data corresponding to a video displayed on the display unit according to a progress status of the forming of the image.
